(19) United States
(12) Patent Application Publication
(10) Pub. No.: US 2006/0056345 A1
(43) Pub. Date: Mar. 16, 2006

(54) Method and system for supporting use of a smart antenna in a wireless local area network

(75) Inventors: Paul Marinier, Brossard (CA); Vincent Roy, Montreal (CA); Arty Chandra, Manhasset Hills, NY (US); Inhyok Cha, Melbourne, FL (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/025,018

(22) Filed: Dec. 29, 2004

Related U.S. Application Data
(60) Provisional application No. 60/608,776, filed on Sep. 10, 2004.

(51) Int. Cl. H04Q 7/00; H04H 1/00

(52) U.S. Cl. 370/329; 370/339; 370/334

(57) ABSTRACT

A method for supporting use of a smart antenna in a wireless local area network (WLAN) including an access point (AP) and a station (STA) begins by selecting an antenna beam by the AP to use for communication with the STA. The selected beam information is sent from the AP to the STA. A packet is transmitted from the STA to the AP, the packet including the selected beam information, whereby the AP uses the selected beam to receive at least a part of the packet.

### CROSS REFERENCE TO RELATED APPLICATION

This application claims the benefit of U.S. Provisional Application No. 60/608,776, filed Sep. 10, 2004, which is incorporated by reference as if fully set forth herein.

### FIELD OF INVENTION

The present invention generally relates to wireless local area networks (WLANs), and more particularly, to a method and apparatus for supporting use of a smart antenna in a WLAN.

### BACKGROUND

In an access point (AP)-based WLAN, multiple stations (STAs) may be associated to a given AP at a given time. If the multiple-access scheme is carrier sense multiple access/collision avoidance (CSMA/CA), such as in 802.11-based WLANs, any STA is susceptible to transmit a packet (also called a “frame”) to its associated AP at any given time. The AP determines which of its associated STAs has transmitted a packet after the packet has been completely received and decoded, based on the source address contained in the medium access control (MAC) header of the packet. The AP needs to have received the whole packet prior to making the source determination, because the error detection bits covering both the MAC header and the MAC payload are received at the end of the packet.

An AP may be equipped with a smart antenna in order to improve the signal-to-noise ratio (SNR) and hence the throughput and/or coverage of AP-to-STA transmissions as well as STA-to-AP transmissions. The term “smart antenna” as used herein means a set of N antennas that have different radiation patterns, typically pointing in selected directions (or not pointing toward any particular direction in the case of an omni-directional antenna). The transmitter and/or receiver of a node (AP or STA) selects the most appropriate antenna (or “beam”) for communicating with its counterpart(s). The most appropriate beam is typically the one that results in the highest signal-to-interference-plus-noise ratio (SINR) at the receiving node in the case of dedicated connections, where a node is transmitting a packet to another specific node.

In a mesh architecture, STAs (or “mesh nodes”) may also be equipped with smart antennas in order to improve the SNR of received signals or for other purposes such as interference reduction.

The multiple-access scheme in 802.11-based WLANs makes selecting the most appropriate beam for receiving packets at the AP difficult when more than one STA is associated to the AP. This is because STAs may be located anywhere around the AP, and therefore the most appropriate beam is generally not the same for each STA. Since the identity of the STA is not known before the packet is completely received, the AP cannot use this information to decide which antenna to select for packet reception. The same problem occurs in a mesh architecture, where a mesh node can be linked to more than one other mesh node.

To circumvent this difficulty, several alternatives are possible, but they all have drawbacks.

1) The AP could restrict itself to using an omni-directional pattern for all packet receptions, thus losing the potential gain from using a smart antenna.

2) The AP could use the signals from multiple beams simultaneously and combine them or select the best beam among them. This solution increases the complexity of the receiver, because the signals from multiple beams must be demodulated.

3) The AP could, just after the start of packet reception, switch among all its available beams in a successive manner, pick the beam that results in the best signal quality, and switch to this beam for the remaining duration of the packet reception. This approach has the drawback that the AP risks incorrectly receiving some bits while it is trying the least suitable beams for a particular packet, resulting in the loss of the packet.

4) The AP could try decoding the MAC address of the sender (contained in the MAC header of the packet) using an omni-directional antenna, and then use the beam most appropriate for the STA identified in the MAC header for the remainder of the packet. The problem with this approach is that the MAC header is transmitted at the same rate as the remainder of the packet. If the omni-directional antenna does not offer sufficient gain for adequate signal quality for the MAC payload, it is unlikely that the MAC header would be decoded correctly. In the opposite case (if the omni-directional antenna did offer sufficient gain), there would be no need to use a smart antenna in the first place.

5) The STAs could be constrained to send every packet using the Request-to-Send/Clear-to-Send (RTS/CTS) procedure. This would allow the AP to identify the sending STA before the arrival of the data packet. However, this is at the cost of a significant throughput penalty due to the overhead of the RTS and CTS packets, which partially defeats the purpose of using smart antennas.

6) The AP could poll STAs using different beams in turn. This approach has two problems. First, it is difficult to attempt to predict the time to spend on each beam in a system with bursty traffic, such as a WLAN. Second, it is difficult to prevent STAs from responding to a poll sent using a beam sub-optimal (but hearable) for them, given the necessary overlap between antenna patterns and the irregularities of the radio environment, such as shadowing.

### SUMMARY

A method for supporting use of a smart antenna in a wireless local area network (WLAN) including an access point (AP) and a station (STA) begins by selecting an antenna beam by the AP to use for communication with the STA. The selected beam information is sent from the AP to the STA. A packet is transmitted from the STA to the AP, the packet including the selected beam information, whereby the AP uses the selected beam to receive at least a part of the packet.

A system for supporting use of a smart antenna in a wireless local area network (WLAN) including an access point (AP) and a station (STA), the system including a first packet and a second packet. The first packet is sent from the AP to the STA and includes a selected beam indicator, a medium access control (MAC) address of the AP, and a MAC address of the STA. The selected beam indicator identifies an antenna beam selected by the AP to use for communication with the STA. The second packet is sent from the STA to the AP and includes the selected beam indicator, whereby the AP receives at least a part of the second packet via the selected beam.

### BRIEF DESCRIPTION OF THE DRAWINGS

A more detailed understanding of the invention may be had from the following description of a preferred embodiment, given by way of example, and to be understood in conjunction with the accompanying drawings, wherein:

FIG. 1 is a diagram showing transmission of data packets between an AP and STAs in accordance with the present invention;

FIG. 2 is a diagram of a frame format including beam indicator information sent by a STA in accordance with the present invention;

FIG. 3 is a diagram of a beam indicator message format sent by an AP in accordance with the present invention;

FIGS. 4a and 4b are diagrams of frame formats including beam indicator information sent by an AP in accordance with the present invention;

FIGS. 5a and 5b are diagrams of alternate frame formats including beam indicator information sent by an AP in accordance with the present invention;

FIG. 6 is a flowchart of a method for transmitting smart antenna information by an AP and a STA in accordance with the present invention; and

FIG. 7 is a flow diagram of an example the method shown in FIG. 6.

### DETAILED DESCRIPTION OF THE PREFERRED EMBODIMENTS

Hereafter, the term “station” (STA) includes, but is not limited to, a wireless transmit/receive unit, a user equipment, a fixed or mobile subscriber unit, a pager, or any other type of device capable of operating in a wireless environment. When referred to hereafter, the term “access point” (AP) includes, but is not limited to, a base station, a Node B, a site controller, or any other type of interfacing device in a wireless environment.

The present invention comprises a method and a signaling scheme that can be implemented in an AP and a STA to enable the use of smart antennas at the AP for the reception of packets from STAs. The method can also be implemented in mesh nodes in the case of a mesh architecture.

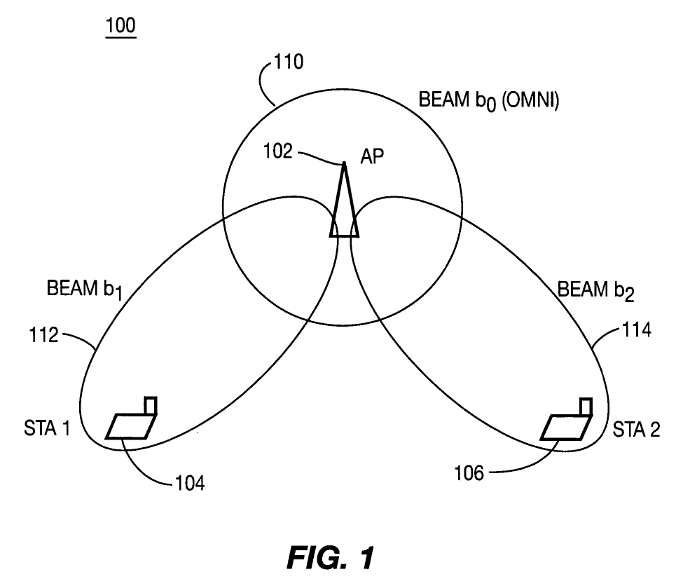

FIG. 1 is a diagram showing a system 100 operating in accordance with the present invention. The system 100 includes an AP 102, a first STA (STA 1) 104 and a second STA (STA 2) 106. The AP 102 transmits on an omni-directional beam (or pattern; b₀) 110, a first directional beam (b₁) 112 with STA 1 104, and a second directional beam (b₂) 114 with STA 2 106. While the omni-directional beam 110 may be able to be received by STA 1 104 and STA 2 106 (albeit faintly), the directional beams 112, 114 are better choices.

A new field, hereinafter called a “beam indicator”, is added after the Physical Layer Convergence Protocol (PLCP) header of most of the packets sent from a STA to an AP, indicating to the AP which of its beams (or antennas) it should select to receive the remainder of the packet (the MAC protocol data unit (PDU)). It is noted that the beam indicator does not need to be sent with all packets from the STA to the AP because certain packets (such as an acknowledgement (ACK) or a CTS) are expected to be received by the AP from a particular STA. If the AP knows in advance which STA will be sending the next packet, it can select the optimal beam for receiving that packet, and the beam indicator is not necessary. However, the beam indicator may also be transmitted in those packets.

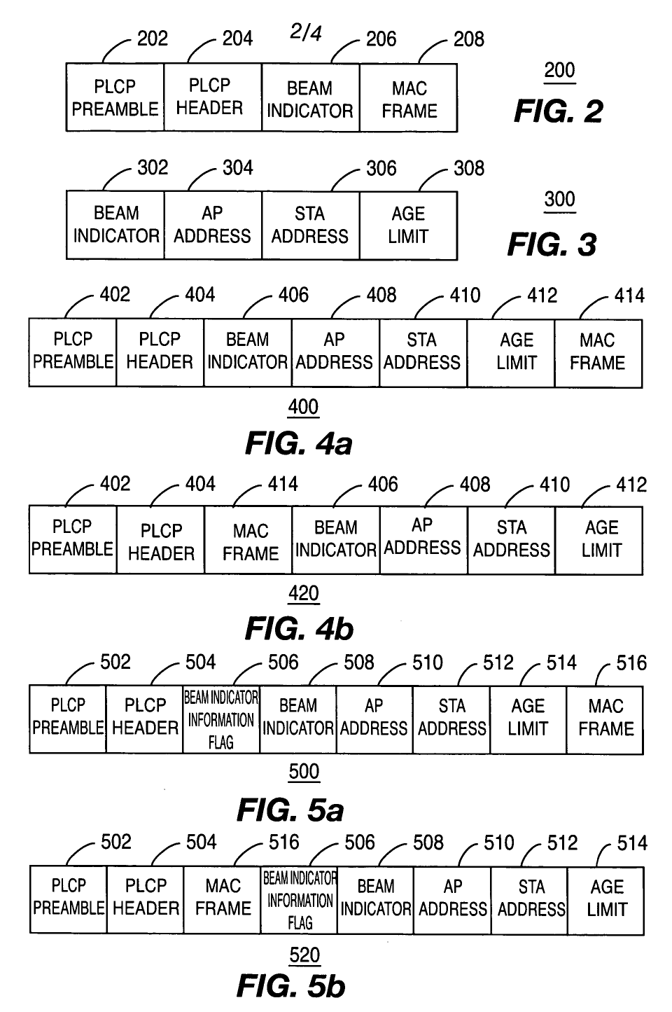

FIG. 2 is a diagram of a frame format 200 including the beam indicator information sent by a STA. The frame 200 is a modified version of a PLCP PDU (PPDU) and includes a PLCP preamble 202, a PLCP header 204, a beam indicator field 206, and a MAC frame 208.

This information is provided by the STA transmitting the packet 200, at the minimum data rate. The AP uses its omni-directional antenna to decode the PLCP header 204 and the beam indicator field 206. After decoding the beam indicator field 206, the AP selects the corresponding beam to receive the remainder of the packet 208, without having to know the identity of the STA sending the packet 200.

The beam indicator 206 is an integer between 0 and Nₐₘₐₓ, where Nₐₘₐₓ is the maximum number of beams that the AP can use. The value of Nₐₘₐₓ may be either fixed for all devices compatible with the system, or signaled by the AP in beacon frames, probe response frames, or other management frames. Preferably, Nₐₘₐₓ is a relatively small integer (i.e., 7 or 15) so as to limit the number of additional bits required for the beam indicator field 206. One of the values is preferably reserved as a default value for situations when the STA does not know what value to use in the beam indicator field 206. When this default value is used, the AP may simply use a beam that is not pointed in a specific direction (such as an omni-directional pattern).

The STA determines which value to use in the beam indicator field 206 based on information provided by the AP in prior AP-to-STA signaling. The required information for this signaling consists of the beam indicator itself, along with the AP and STA MAC addresses. Optionally, an “age limit” may be added to indicate to the STA a maximum time beyond which the beam indicator information is deemed unreliable or invalid. The age limit may be a fixed value, or may be signaled from beacon frames, probe response frames, or other management frames. In the latter case, the age limit may be set adaptively by the AP based on STA mobility considerations.

There are several signaling possibilities for the AP to transfer the beam indicator information to the STA. One method is for the AP to send a special packet (a beam indicator message) containing only the information required for this purpose (AP and STA addresses, beam indicator, optional age limit). FIG. 3 is a diagram of a beam indicator message 300 sent by an AP. The message 300 includes a beam indicator field 302, an AP address field 304, a STA address field 306, and an optional age limit field 308. The order of the fields 302-308 is exemplary, and the fields 302-308 of the message 300 can be in any order.

In a unicast situation, the STA preferably sends back an ACK so that the AP can re-transmit the packet 300 if the STA did not successfully receive it. If the AP has to update the beam indicator for several STAs, it may send a multicast message for these STAs containing their respective beam indicator values.

Another signaling possibility is for the AP to insert or piggyback the required information onto a packet containing other data destined to the STA. The information could be added after the PLCP header, after the MAC PDU, or as another field in the MAC header. FIGS. 4a and 4b are diagrams of frame formats 400, 420 including the beam indicator information sent by an AP. The frames 400, 420 are modified versions of the PPDU.

FIG. 4a shows a frame 400 that adds the beam indicator information after the PLCP header. The frame 400 includes a PLCP preamble 402, a PLCP header 404, a beam indicator field 406, an AP address field 408, a STA address field 410, an optional age limit field 412, and a MAC frame 414.

FIG. 4b shows a frame 420 that adds the beam indicator information after the MAC frame 414. The fields of the frame 420 are the same as the frame 400, with the difference being the order of the fields.

Another signaling possibility is to add a flag indicating whether the beam indicator information is present or not. This flag would allow the AP to not send the beam indicator information in every packet destined to the STA. The beam indicator information can be sent periodically (for example, once every five seconds) and/or on an event driven basis (for example, on a change in the transmitted beam at the AP to a certain STA).

FIGS. 5a and 5b are diagrams of alternate frame formats 500, 520 including the beam indicator information sent by an AP, incorporating the beam indicator information flag. The frames 500, 520 are modified versions of the PPDU. FIG. 5a shows a frame 500 including a PLCP preamble 502, a PLCP header 504, a beam indicator information flag 506, a beam indicator field 508, an AP address field 510, a STA address field 512, an optional age limit field 514, and a MAC frame 516. The flag 506 is set only if the beam indicator information (fields 508-514) is provided in the frame 500.

FIG. 5b shows a frame 520 that adds the beam indicator information after the MAC frame 516. The fields of the frame 520 are the same as the frame 500, with the difference being the order of the fields.

The STA fills the beam indicator field 206 in the STA-to-AP transmissions (packet 200) with the latest beam indicator (302, 406, 508) signaled by the AP for this STA, if this latest signaling was received before its age limit expired (or at all). Otherwise, the STA fills the beam indicator field 206 with the default value, as mentioned above. For each value of the beam indicator, the AP knows which of its beams (or antennas) the indicator corresponds to; the STA does not need to know this correspondence.

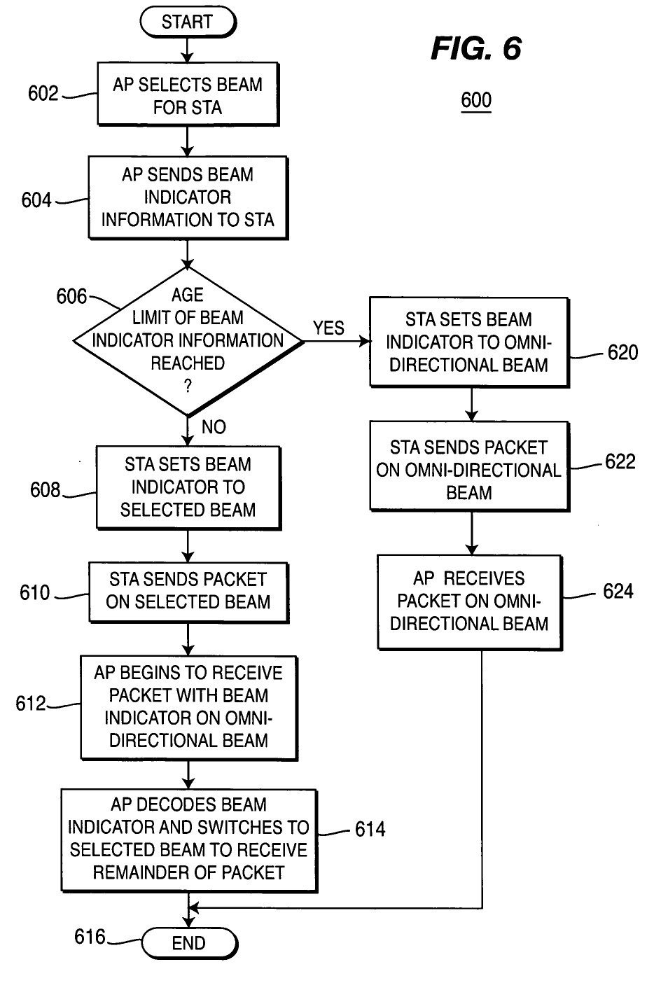

FIG. 6 is a flowchart of a method 600 for transmitting smart antenna information by an AP and a STA. The method 600 begins by the AP selecting a beam for communication to the STA and selecting the beam indicator corresponding to the selected beam (step 602). Preferably, although not mandatory, the AP chooses the beam that maximizes the signal level or the signal-to-interference ratio (SIR) at its receiver. There are a variety of methods by which the AP can learn which beam maximizes the SIR for a specific STA.

For example, the AP may try different beams when receiving packets that are expected from a particular STA, and pick the beam that resulted in the best quality of the received signal. Examples of expected packets include: an ACK following the transmission of a data packet to a particular STA, and a CTS packet following the transmission of an RTS packet to a particular STA. With expected packets, it may not be necessary for the STA to add the beam indicator field 206 after the PLCP header 204 because the packets are expected by the AP to be sent by a certain STA, and therefore the AP would already know which beam to use.

The AP then sends the beam indicator information to the STA (step 604). The beam indicator information (as explained in greater detail above) includes the beam indicator, the AP's address, the STA's address, and an optional age limit for expiration of the beam indicator information. The method 600 assumes that the age limit is present in the beam indicator information.

A determination is made by the STA if the age limit of the beam indicator information has been reached; i.e., whether the beam indicator information is still valid (step 606). If the age limit has not been reached, then the STA sets the beam indicator for a packet to be transmitted to the selected beam (step 608). The STA sends the packet with the beam indicator information on the selected beam (step 610). The AP begins to receive the packet from the STA on the omni-directional beam (step 612). The AP decodes the beam indicator information contained in the packet and switches the antenna to the selected beam to receive the remainder of the packet (step 614). The method then terminates (step 616).

If the age limit of the beam indicator information has been reached; i.e., the beam indicator information is no longer valid (step 606), then the STA sets the beam indicator for a packet to be transmitted to the omni-directional beam (or pattern; step 620). The STA then sends the packet on the omni-directional beam (step 622). The AP receives the packet on the omni-directional beam (step 624) and the method terminates (step 616). Because the packet is being transmitted on the omni-directional beam (since the packet from the STA does not include the beam indicator information or the STA has set the beam indicator to the default value), there is no need for the AP to change its antenna beam.

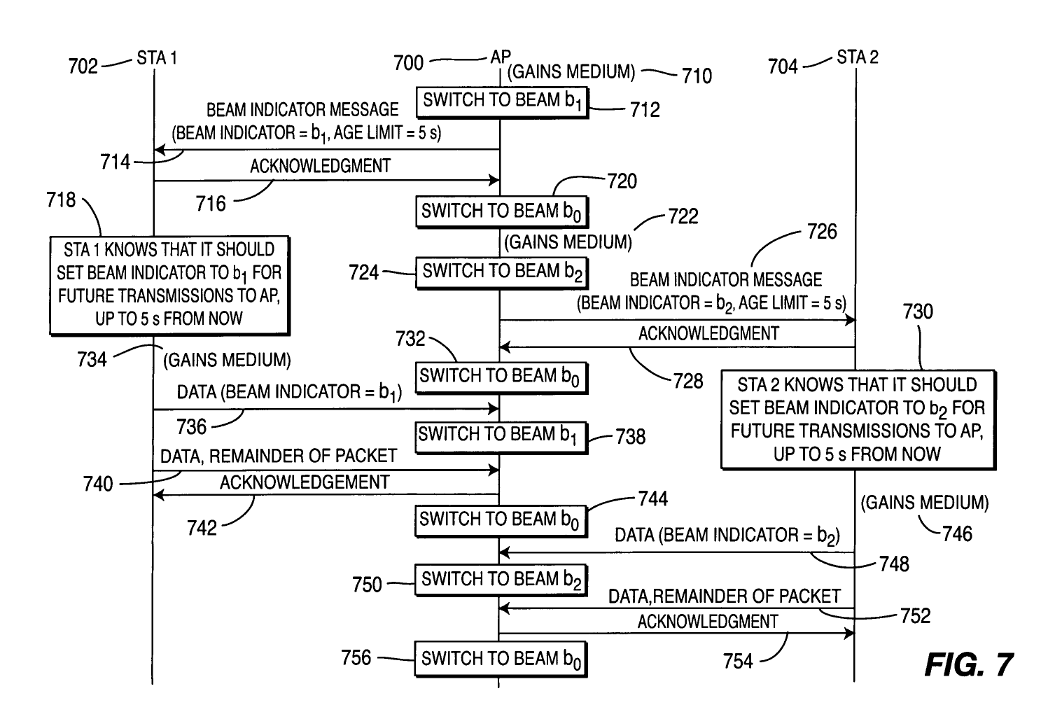

FIG. 7 shows an example of the method 600. In this example, it is assumed that the AP 700 has already decided that the best beams for communicating with STA 1 702 and STA 2 704 are b₁ and b₂, respectively (as shown in FIG. 1).

FIG. 7 shows a possible sequence of events where STA 1 702, STA 2 704, and the AP 700 communicate with each other. First, the AP desires to transmit a packet to STA 1. After gaining access to the medium (step 710), the AP switches to beam b₁ (step 712) and transmits a data packet to STA 1 including a beam indicator message, with the beam indicator (b₁) and an age limit for the use of this beam indicator (five seconds; step 714). STA 1 then sends an ACK to the AP (step 716). From that time (and up to five seconds from that time), STA 1 knows that if it has to transmit a packet (200, as shown in FIG. 2) to the AP, it should set the beam indicator field (206) to b₁ (step 718). After receiving the ACK from STA 1, the AP switches its antenna to an omni-directional pattern (b₀; step 720).

Next, the AP gains access to the medium again (step 722) and switches to beam b₂ (step 724) in order to transmit a packet to STA 2, including a beam indicator message, with the beam indicator (b₂) and an age limit for the use of this beam indicator (five seconds; step 726). STA 2 then sends an ACK to the AP (step 728). STA 2 knows that it should set the beam indicator field (206) to b₂ for any packet it transmits to the AP (other than an ACK or a CTS), for up to five seconds from that time (step 730). After receiving the ACK from STA 2, the AP switches its antenna to an omni-directional pattern (b₀; step 732).

STA 1 then gains access to the medium (step 734) and transmits a data packet to the AP with the beam indicator field (206) set to b₁ (assuming less than five seconds has elapsed; step 736). After decoding the beam indicator field, the AP immediately switches to beam b₁ (step 738) to decode the remainder of the packet (step 740). After the end of the packet reception, the AP sends an ACK to STA 1 (step 742) and switches its antenna to the omni-directional pattern (b₀; step 744).

Then STA 2 gains access to the medium (step 746) and transmits a data packet to the AP with the beam indicator field (206) set to b₂ (assuming less than five seconds has elapsed; step 748). After decoding beam indicator field, the AP immediately switches to beam b₂ (step 750) to decode the remainder of the packet (step 752). After the end of the packet reception, the AP sends an ACK to STA 1 (step 754) and switches its antenna to the omni-directional pattern (b₀; step 756).

It is noted that if the age limit of the beam indicator information has expired (five seconds in this example), a STA (either STA 1 or STA 2) would set the beam indicator field (206) to b₀ (the default value).

The invention allows taking advantage of the smart antenna at the AP without resulting in any major inconvenience. The addition of the beam indicator field in the PLCP header does not result in excessive overhead, since the number of possible beams can usually be limited to eight or less (e.g., three or four bits for the beam indicator field).

For backward compatibility purposes, a field of the PLCP header may be given a new value for the packets transmitted from STAs implementing the present invention, so that the AP can determine if an incoming packet was transmitted from a STA implementing the invention or not. For example, one of the currently reserved bits in the “service” field of the PLCP header could be used to indicate whether the STA implements this invention (and therefore if there will be a beam indicator field after the PLCP header). If not, the AP knows that it should not expect the beam indicator field after the PLCP header and could simply use the omni-directional pattern to decode the remainder of the packet.

The present invention also applies in the case of a mesh architecture where a mesh node is susceptible of receiving packets from more than one other mesh node. In that case, a mesh node plays the role of a STA and of an AP as described above. This means that a mesh node A uses the beam indicator field when transmitting to another mesh node B, using the value of the beam indicator that mesh node B has previously signaled to mesh node A. Conversely, mesh node B uses the beam indicator field when transmitting to mesh node A, using the value of the beam indicator that mesh node A has previously signaled to mesh node B.

As an alternative to having a beam indicator field after the PLCP header, the STA could add its address after the PLCP header. This is not as efficient a solution because the STA address is 48 bits long, compared with three or four bits for the beam indicator. Another alternative would be to replace the beam indicator field with an arbitrary STA index assigned by the AP to the STA upon association and/or higher layer signaling thereafter. The STA index could be relatively short (less than ten bits at its maximum value), depending on the maximum number of associated STAs. The AP would look up and use the current best beam for the STA index specified in the preamble. The AP would not need to then signal a beam indicator to the STA in every AP-to-STA packet, but there would be more additional bits after the PLCP preamble.

Although the features and elements of the present invention are described in the preferred embodiments in particular combinations, each feature or element can be used alone (without the other features and elements of the preferred embodiments) or in various combinations with or without other features and elements of the present invention. While specific embodiments of the present invention have been shown and described, many modifications and variations could be made by one skilled in the art without departing from the scope of the invention. The above description serves to illustrate and not limit the particular invention in any way.

What is claimed is:

1. A method for supporting use of a smart antenna in a wireless local area network (WLAN), the WLAN including an access point (AP) and a station (STA), the method comprising the steps of:
selecting an antenna beam by the AP to use for communication with the STA;
sending the selected beam information from the AP to the STA; and
transmitting a packet from the STA to the AP, the packet including the selected beam information, whereby the AP uses the selected beam to receive at least a part of the packet.

2. The method according to claim 1, wherein the selecting step includes selecting an antenna beam with a maximum signal level.

3. The method according to claim 1, wherein the selecting step includes selecting an antenna beam with a maximum signal to interference ratio.

4. The method according to claim 1, wherein the sending step includes sending a beam indicator, the AP's medium access control (MAC) address, and the STA's MAC address.

5. The method according to claim 4, wherein the sending step further includes sending an age limit for the beam indicator, wherein the selected beam will only be used if the age limit has not expired.

6. The method according to claim 1, wherein the sending step includes sending the selected beam information in a separate message.

7. The method according to claim 1, wherein the sending step includes sending the selected beam information as part of an existing frame type.

8. The method according to claim 7, wherein the sending step further includes sending a beam indicator information flag, to indicate the presence of selected beam information in the frame.

9. The method according to claim 1, wherein the sending step includes switching the antenna of the AP to the selected beam prior to sending the selected beam information.

10. The method according to claim 9, wherein the sending step further includes switching the antenna of the AP to an omni-directional pattern after sending the selected beam information on the selected beam.

11. The method according to claim 1, further comprising the step of:
sending an acknowledgement from the STA to the AP upon successful receipt of the selected beam information.

12. The method according to claim 1, further comprising the steps of:
receiving a first part of the packet at the AP via an omni-directional beam, the first part of the packet including the selected beam information;
switching the antenna of the AP to the selected beam as specified in the selected beam information; and
receiving a second part of the packet at the AP via the selected beam.

13. The method according to claim 12, wherein the switching step includes decoding the first part of the packet to determine the selected beam.

14. A system for supporting use of a smart antenna in a wireless local area network (WLAN), the WLAN including an access point (AP) and a station (STA), the system comprising:
a first packet, sent from the AP to the STA, said first packet including a selected beam indicator, a medium access control (MAC) address of the AP, and a MAC address of the STA, said selected beam indicator identifying an antenna beam selected by the AP to use for communication with the STA; and
a second packet, sent from the STA to the AP, said second packet including said selected beam indicator, whereby the AP receives at least a part of said second packet via the selected beam.

15. The system according to claim 14, wherein said first packet is sent as a separate message from the AP to the STA.

16. The system according to claim 14, wherein said first packet is part of an existing frame type.

17. The system according to claim 14, wherein said first packet further includes an age limit for said selected beam indicator, wherein the selected beam will only be used if said age limit has not expired.

18. The system according to claim 14, wherein said first packet further includes a beam indicator information flag, to indicate the presence of said selected beam indicator in said packet.

19. The system according to claim 14, wherein:
a first part of said second packet is received at the AP via an omni-directional beam, said first part of said second packet including said selected beam indicator;
the AP switches its antenna to the selected beam as specified in said selected beam indicator; and
a second part of said second packet is received at the AP via the selected beam.
